(19) United States
(12) Patent Application Publication
(10) Pub. No.: US 2024/0384150 A1
(43) Pub. Date: Nov. 21, 2024

(54) FLUIDIZED ARABIAN SAND AS HEAT TRANSFER MEDIA FOR HYDROGEN ECONOMY

(71) Applicant: SAUDI ARABIAN OIL COMPANY, Dhahran (SA)

(72) Inventors: Abdulaziz S. Al-Qasim, Dammam (SA); Yuguo Wang, Dhahran (SA)

(73) Assignee: SAUDI ARABIAN OIL COMPANY, Dhahran (SA)

(21) Appl. No.: 18/320,447

(22) Filed: May 19, 2023

(51) Int. Cl. C09K 5/16

(52) U.S. Cl. CPC C09K 5/16

(57) ABSTRACT

Embodiments disclosed relate to a method for producing, storing, and transporting a hydrogen gas as a liquid hydrogen fuel. The method includes using sand as a thermal energy storage medium for absorbing, storing, and transferring energy from an energy source to produce a power source, providing the power source to a water electrolysis process to produce a hydrogen gas and an oxygen gas, and the hydrogen gas may be send to a hydrogenation plant to produce liquid hydrogen fuel, and transporting the liquid hydrogen fuel via a transportation system from the hydrogenation plant to a point of consumption.

### BACKGROUND

Hydrogen has the potential to be an important energy carrier which may be used as a clean fuel as an alternative to major fossil fuels. In addition to being a clean, reliable, and affordable energy source, hydrogen has the major advantage that the product of its combustion with oxygen is water, in contrast to other fuel sources which produce carbon products via combustion that contribute to the greenhouse effect. Hydrogen is expected to play a major role in future clean and renewable energy systems.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for producing, storing, and transporting a hydrogen gas as a liquid hydrogen fuel. The method includes using a sand for absorbing, storing and transferring energy from an energy source to produce a power source, providing the power source to a water electrolysis process to produce a hydrogen gas and an oxygen gas, providing the hydrogen gas and an organic aromatic solvent to a hydrogenation plant to produce the liquid hydrogen fuel, and transporting the liquid hydrogen fuel via a transportation system from the hydrogenation plant to a point of consumption.

Other aspects and advantages of the claimed subject matter will be apparent from the following description and the appended claims.

### BRIEF DESCRIPTION OF DRAWINGS

FIG. 1 illustrates a flow diagram of a system of production of a hydrogen fuel according to one or more embodiments herein.

FIG. 2 illustrates a flow diagram of a process for using solar energy to generate power according to one or more embodiments herein.

FIG. 3 illustrates an electrolysis process.

FIG. 4 illustrates a process for hydrogenating an organic aromatic solvent according to one or more embodiments herein.

### DETAILED DESCRIPTION

One or more embodiments herein generally relate to a method for producing, storing, and transporting using hydrogen gas as a renewable fuel source to promote a circular economy.

Hydrogen can be used in fuel cells to produce electricity, with the only product being water. The energy efficiency of hydrogen fuel cells is as high as 60%, whereas other possible fuel systems are typically only about 34% efficient. Hydrogen in the gas phase is difficult and dangerous to store and transport because the gas is very flammable and explosive. Instead, hydrogen can be stored in a liquid form as a catalytically liquid hydrogen fuel. The overall production process of this liquid hydrogen fuel may include capturing renewable energy, such as solar energy, storing and transporting solar energy as heat in a thermal energy storage medium, such as sand, producing a power source from the stored energy, providing the power source to a water electrolysis process to produce hydrogen gas, providing the hydrogen gas to a hydrogenation plant to be converted into a liquid hydrogen fuel, transporting the liquid hydrogen fuel, and dehydrogenating the liquid hydrogen fuel to recover the hydrogen gas at a point of consumption.

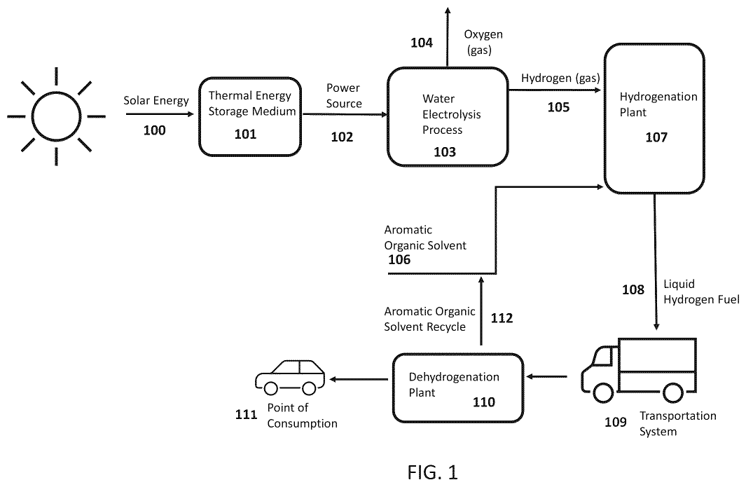

In one aspect, embodiments disclosed herein relate to a method for producing hydrogen gas to be used as a renewable fuel source. An overall description of the method is shown in FIG. 1. Solar energy 100 may be provided to a thermal energy storage medium 101 which may store and transfer the solar energy in the form of heat and convert the heat to energy as a power source 102. The power source 102 may be used to provide power to a water electrolysis process 103. The water electrolysis process 103 produces oxygen gas 104 and hydrogen gas 105. The hydrogen gas 105 may then be provided to a hydrogenation plant 107 where the hydrogen gas reacts with an aromatic organic solvent 106 to produce a liquid hydrogen fuel 108. The liquid hydrogen 108 fuel may be safely transported by a transportation mechanism 109 to a dehydrogenation plant 110 near one or more points of consumption 111 to provide a renewable energy source for various applications. The aromatic organic solvent produced in the dehydrogenation plant 110 may be recycled back to the hydrogenation plant 107 via an aromatic organic solvent recycle 112. In some embodiments, the point of consumption 111 may be equipped with a small dehydrogenation plant, allowing for the use of the liquid hydrogen fuel 108 without intermediate dehydrogenation.

An energy source, for example solar energy, may be used as a renewable source of heat, but with limitations. In the case of solar energy, the energy source is time-dependent in that solar energy is only available during sunshine periods. However, solar energy can be stored for later use in thermal energy storage systems. In such systems, a storage medium is heated to store thermal energy. Examples of thermal energy storage (TES) media include solid materials, such as sand and molten salts. Molten salts typically have very high thermal transfer properties and are used in a range of industries. Compared to molten salt as a TES medium, sand has less ideal thermal properties. However, sand has very high temperature usage (greater than 1000° C., and no lower temperature limit), low cost, and very high thermal, chemical, and mechanical stability after long periods of fluidization and thermal aging. Sand can be stored in insulated tanks as a heat transfer medium to retain thermal energy to be used for power generation.

In one or more embodiments, Arabian sand is used as the TES medium. Arabian sand is widely available and therefore offers a very low cost solution as a TES. Quartzose Arabian sand, containing 99% quartz, has a high specific heat capacity and spectral absorbance among common types of sands. These thermal properties make quartzose Arabian sand an excellent TES. For example, the quartzose Arabian sand is capable of withstanding temperatures up to and in excess of 1000° C. This may allow for high temperature output or high thermal energy storage.

In one or more embodiments, the oxygen gas produced from the water electrolysis process may be provided to downstream processes to produce thermal energy. For example, oxy-combustion reactions use pure oxygen as a fuel source for combustion and produce water and carbon dioxide (CO₂), along with thermal energy. CO₂ is considered a greenhouse gas and therefore it is beneficial to capture CO₂ from entering the atmosphere, and the captured CO₂ can be sequestered underground. Oxy-combustion is more efficient than traditional combustion and produces about 75% less flue gas, where the flue gas contains about 70% CO₂ by volume.

In one or more embodiments, the method for using a sand to store and transfer energy from the energy source to produce a power source further includes capturing energy from an energy source. After energy is captured from the energy source, the captured energy is stored in the sand as thermal energy. Then, the stored thermal energy is transferred to a power generation system. The power generation system is operated to produce the power source. Finally, the power source is provided to a water electrolysis process.

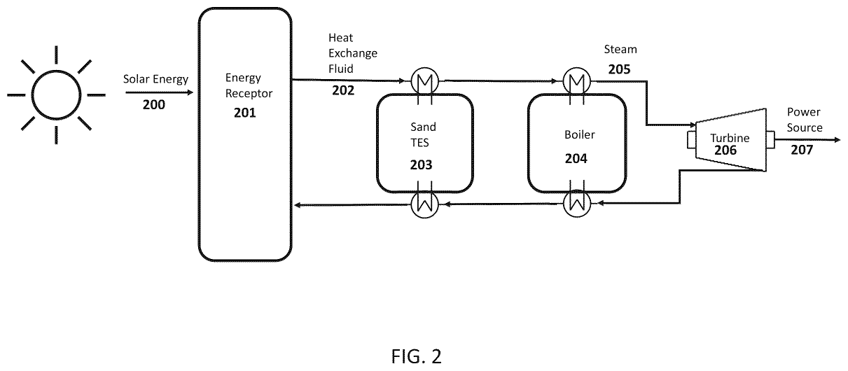

FIG. 2 illustrates an example of a process of using sand as a TES to store and transfer energy from an energy source to produce a power source. Solar energy 200 is captured in an energy receptor 201. In one or more embodiments, the energy receptor may be a solar power plant that collects solar energy using unglazed solar collectors, transpired solar air collectors, flat-plate solar collectors, evacuated tube solar collectors, concentrating solar systems, or other technologies configured to receive solar energy. The energy receptor 201 is connected to a system which provides heat exchange through a heat exchange fluid 202. The sand TES 203 receives energy from the heat exchange fluid and stores the energy for use at a later time. The power generation system may include a heat exchanging unit, such as a boiler 204, and a turbine 206. The boiler uses energy from the sand TES 203 and turbine exhaust to vaporize the heat exchange fluid to high pressure steam 205 which is converted to a power source 207 by expansion in the turbine 206.

Energy stored in and transferred by the TES medium may be used for any application that requires a power source. In one or more embodiments disclosed herein, such energy is used to produce a power source which drives a water electrolysis process.

The water electrolysis process consists of decomposition of water into oxygen gas and hydrogen gas by passing an electric current through a pure water source. Water decomposition requires, in practice, about 1.5 volts of energy. As described previously, this energy may be provided by renewable energy, such as solar energy, which is stored and transferred in the form of heat by a TES medium such as sand.

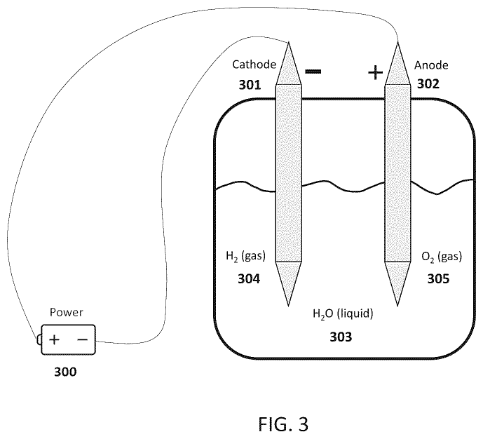

An example water electrolysis process is illustrated in FIG. 3. First, a power source 300 is connected to a cathode 301 and an anode 302. The cathode and anode are then inserted into a water source 303. The power source 300 provides an electric current to the cathode which reduces hydrogen ions to hydrogen gas 304, according to the following half reaction:

2H⁺(aq)+2e⁻→H₂(g) (I)

At the positively charged anode, an oxidation reaction occurs where the pure water source is oxidized to produce electrons, hydrogen ions, and the oxygen gas 305, according to the following half reaction:

2H₂O(1)→4H⁺(aq)+4e⁺O₂(g) (II)

Combining the two half reactions yields an overall oxidation-reduction reaction:

2H₂O(1)→3H₂(g)+O₂(g) (III)

Hydrogen has the potential to be a clean, reliable, and affordable energy source and can be used as an alternative to major fossil fuels. Hydrogen in its gaseous state, however, is very flammable and explosive. This presents complications with storing, handling, and transporting hydrogen gas. One way to store hydrogen gas in a safe and easy to use state is in the form of a reversible, organic, liquid hydrogen fuel. Conversion of hydrogen gas into such a liquid hydrogen fuel may be done, for example, in a hydrogenation plant. An aromatic organic solvent may be provided to the hydrogenation plant to be reacted with the hydrogen gas to produce the liquid hydrogen fuel through a reversible reaction.

The aromatic organic solvent may be benzene, toluene, naphthalene, N-ethyl carbazole, or similar alkylated aromatic compounds. In one or more embodiments, the organic solvent is toluene.

Depending on the organic solvent used, the liquid hydrogen fuel may be cyclohexane, methyl cyclohexane, tetralin, decalin, 1,2-ethyl carbazole, or similar hydrogenated cyclic compounds. In one or more embodiments, the liquid hydrogen fuel is methylcyclohexane.

The chemical reaction between toluene gas and hydrogen gas useful for one or more embodiments is shown below:

C₇H₈(g)+4H₂(g)→H₂(g)+C₇H₁₄(g) (IV)

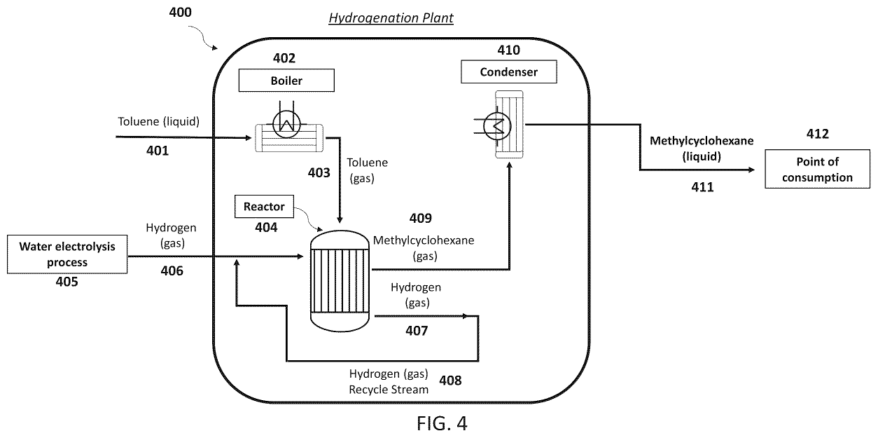

In one or more embodiments, hydrogen gas produced from the electrolysis of water is sent to a hydrogenation plant along with an aromatic organic solvent, such as toluene, to produce a liquid hydrogen fuel, methylcyclohexane, as shown in FIG. 4. A hydrogenation plant 400 may include any processes necessary to store hydrogen gas in a liquid hydrogen fuel. In some embodiments, toluene 401 is provided to a hydrogenation plant in liquid form 401. Because the hydrogenation reaction takes place in the gaseous phase, the liquid toluene stream is first vaporized, for example, in a boiler 402 to produce toluene gas 403. Hydrogen gas 406 from the water electrolysis process 405 is provided to a reactor 404, along with the toluene gas 403. The products of the reaction are hydrogen gas 407 and methylcyclohexane gas 409. Hydrogen gas may be recycled in a hydrogen gas recycle stream 408 and sent back to the reactor. The methylcyclohexane gas stream 409 is sent to a condenser 410 to be condensed into liquid form. Finally, the end product, methylcyclohexane liquid 411, is provided to a downstream process 412.

Methylcyclohexane is a stable product that has a low risk of explosion. However, in order for the methylcyclohexane to be used as fuel, the methylcyclohexane must undergo dehydrogenation to liberate the stored hydrogen from the cyclic hydrocarbon. In some embodiments, the methylcyclohexane can be transported to a dehydrogenation facility closer to the final point of consumption. In other embodiments, the final point of consumption may be equipped with an internal dehydrogenation plant to be able to make usable hydrogen ad hoc. In either case, the toluene recovered from the dehydrogenation reaction can be recycled to the hydrogenation plant as the organic aromatic solvent.

In one aspect, embodiments disclosed herein relate to a method for transporting hydrogen gas, in the form of a liquid hydrogen fuel to be used as a renewable fuel source.

As mentioned above, storing and transporting hydrogen gas in the form of a liquid hydrogen fuel to be used as an energy source is safe and convenient, compared to storing and transporting hydrogen gas. In this form, reversible organic liquid hydrogen may be easily transported, for example, by existing oil and gas pipelines or oil tankers.

In one or more embodiments, methylcyclohexane liquid may be used as a liquid hydrogen fuel to provide hydrogen gas as a renewable energy source according to the following reaction:

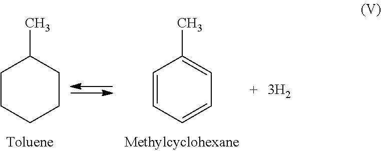

Equation V shows the hydrogenation and dehydrogenation reaction of methylcyclohexane to provide hydrogen gas as a renewable energy source.

In one or more embodiments, the liquid hydrogen fuel is used for example, in hydrogen fuel cells, desalination process for salt water, or hydrogen fuel.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures.

What is claimed:

1. A method for producing, storing, and transporting a hydrogen gas as a liquid hydrogen fuel, comprising:
using a sand for absorbing, storing and transferring energy from an energy source to produce a power source;
providing the power source to a water electrolysis process to produce a hydrogen gas and an oxygen gas;
providing the hydrogen gas and an organic aromatic solvent to a hydrogenation plant to produce the liquid hydrogen fuel; and
transporting the liquid hydrogen fuel via a transportation system from the hydrogenation plant to a point of consumption.

2. The method of claim 1, wherein using the sand to store and transfer energy from the energy source to produce the power source further comprises:
capturing energy from the energy source;
storing the captured energy in the sand as thermal energy;
transferring the stored energy to a power generation system;
operating the power generation system to produce the power source; and
providing the power source to a water electrolysis process.

3. The method of claim 1, wherein the water electrolysis process further comprises:
generating an electric current from the power source;
inserting an anode and a cathode into a pure water source;
passing the electric current through the cathode, producing the hydrogen gas; and
oxidizing the pure water source at the anode producing the oxygen gas.

4. The method of claim 1, wherein providing the hydrogen gas and the organic aromatic solvent to the hydrogenation plant to produce the liquid hydrogen fuel further comprises:
vaporizing the organic aromatic solvent to produce an organic aromatic vapor;
hydrogenating the organic aromatic vapor producing a hydrogenated organic vapor compound; and
condensing the hydrogenated organic vapor compound.

5. The method of claim 1, wherein the transportation system includes existing oil pipelines or via oil tankers.

6. The method of claim 1, wherein the sand is an Arabian sand.

7. The method of claim 6, wherein the Arabian sand is a quartzose sand.

8. The method of claim 1, wherein the energy source is solar energy.

9. The method of claim 1, further comprising combusting the oxygen gas in an oxy-combustion reaction.

10. The method of claim 1, wherein the organic aromatic solvent is selected from the group consisting of benzene, toluene, naphthalene, N-ethyl carbazole, and similar alkylated aromatic compounds.

11. The method of claim 1, wherein the liquid hydrogen fuel is selected from the group consisting of cyclohexane, methyl cyclohexane, tetralin, decalin, 12-ethyl carbazole, and similar hydrogenated cyclic compounds.

12. The method of claim 11, further comprising dehydrogenating the methylcyclohexane to recover the organic aromatic solvent and the hydrogen gas and using the hydrogen gas in the point of consumption.

13. The method of claim 12, wherein the point of consumption includes one or more of liquid hydrogen fuel cells, water desalination plants, and hydrogen fuel storage tanks.
